(19) United States
(12) Patent Application Publication
(10) Pub. No.: US 2012/0321378 A1
(43) Pub. Date: Dec. 20, 2012

(54) CORNER JOINT SYSTEM FOR FURNITURE PANELS

(75) Inventors: Gustavo Velez, JR., San Leandro, CA (US); Bernardino Rabutan, Mandaue City (PH); Ming Jun (James) Chen, Guangdong (CN)

(73) Assignee: WHALEN FURNITURE MANUFACTURING, INC., San Diego, CA (US)

(21) Appl. No.: 13/405,548

(22) Filed: Feb. 27, 2012

Related U.S. Application Data
(60) Provisional application No. 61/496,808, filed on Jun. 14, 2011.

(51) Int. Cl. F16B 3/00

(52) U.S. Cl. 403/300

(57) ABSTRACT

A corner joint system for fastening two perpendicular furniture panels to form a box corner includes first and second male connector rails and a female connector rail. The male connector rails each include a base having a longitudinal spline extending inwardly from an inner surface. The male connector rails are secured in adjacent relation to adjacent corner surfaces of the furniture panels such that the respective splines are arranged in adjacent perpendicular relation. The female connector rail includes a main body portion having an upper end and a lower end, and two perpendicular, longitudinal, spline channels extending upwardly through the main body portion from the lower end to the upper end. The spline channels of the female connector rail are slidably received in interfitting relation over the adjacent splines of the male connector rails to cooperatively capture the splines and interlock the rails, forming a rigid, right angle box corner.

### CROSS-REFERENCE TO RELATED APPLICATIONS

This application claims priority to earlier filed U.S. Provisional Patent Application No. 61/496,808, filed Jun. 14, 2011, the entire contents of which are incorporated herein by reference.

### BACKGROUND OF THE INVENTION

The instant invention relates to hardware systems for fastening the corners of furniture boxes, and more particularly to a corner joint system for fastening the corners of drawer boxes in ready to assembly furniture.

### SUMMARY OF THE INVENTION

The instant invention provides a corner joint system for fastening two furniture panels arranged in perpendicular relation to form a rigid, right angle box corner. The corner joint system generally includes first and second male connector rails and a female connector rail.

The first and second male connector rails each include a base having an inner surface and an outer surface, and a longitudinal spline extending inwardly from the inner surface. The first and second male connector rails are secured in perpendicular adjacent relation to perpendicular adjacent corner surfaces of the furniture panels such that the respective splines are arranged in adjacent perpendicular relation. Preferably, the male connector rails are secured using threaded fasteners which extend through preformed apertures in the opposing ends of the bases. Additionally, the male connector rails each include a pair of spaced alignment posts which extend outwardly from the outer surface of the base and are seated into pre-drilled holes in the furniture panel wall surfaces.

The female connector rail includes a main body portion having an upper end and a lower end, and two perpendicular, longitudinal, spline channels extending upwardly through the main body portion from the lower end toward the upper end. The spline channels each have a shape which is complementary to the shape of the splines. The spline channels of the female connector rail are slidably received in interfitting relation over the adjacent splines of the male connector rails to cooperatively capture the splines, interlock the rails and retain the furniture panels in assembled relation to form a rigid, right angle box corner.

Objectives, features and advantages of the invention shall become apparent as the description thereof proceeds when considered in connection with the accompanying illustrative drawings.

### DESCRIPTION OF THE DRAWINGS

In the drawings which illustrate the best mode presently contemplated for carrying out the present invention:

FIG. 1 is an exploded perspective view of the corner joint system of the present invention;

FIG. 2 is another exploded perspective view thereof with the male connector rails secured to adjacent drawer box panels;

FIG. 3 is partially exploded perspective view thereof with the female connector rail being slidably engaged onto the splines of the male connector rails;

FIG. 4 is a perspective view thereof with the female connector rail fully installed;

FIG. 5 is a cross-sectional view thereof taken along line 5-5 of FIG. 4;

FIG. 6 is a perspective view of a male connector rail;

FIG. 7 is a front view thereof;

FIG. 8 is a rear view thereof;

FIG. 9 is a right side view thereof;

FIG. 10 is a left side view thereof;

FIG. 11 is a top view thereof;

FIG. 12 is a bottom view thereof;

FIG. 13 is a rear perspective view of the female connector rail;

FIG. 14 is a front view thereof;

FIG. 15 is a right side view thereof;

FIG. 16 is a left side view thereof;

FIG. 17 is a back view thereof;

FIG. 18 is a top view thereof; and

FIG. 19 is a bottom view thereof.

### DESCRIPTION OF A PREFERRED EMBODIMENT

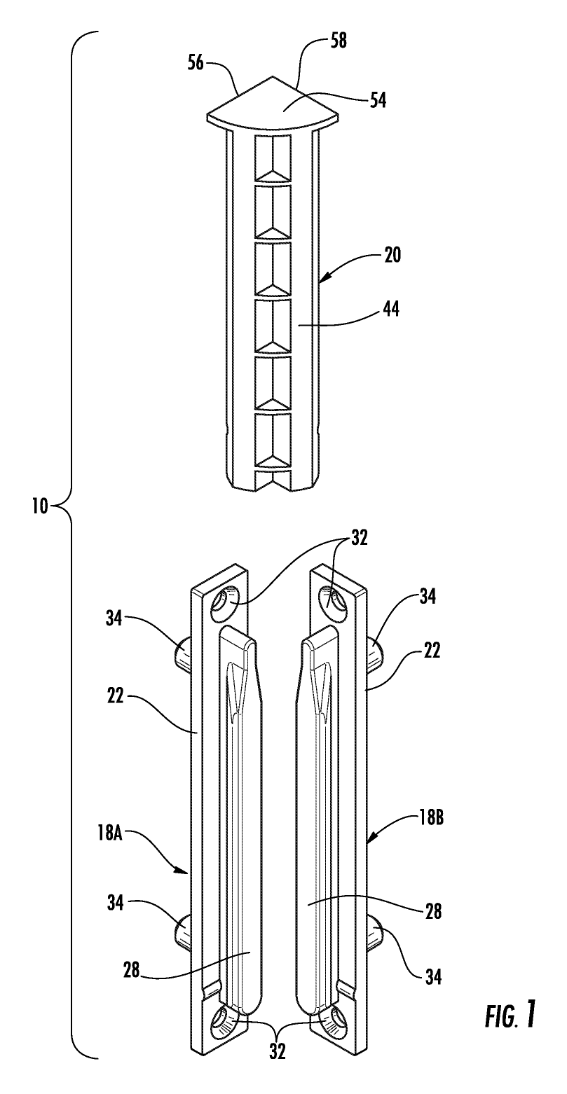

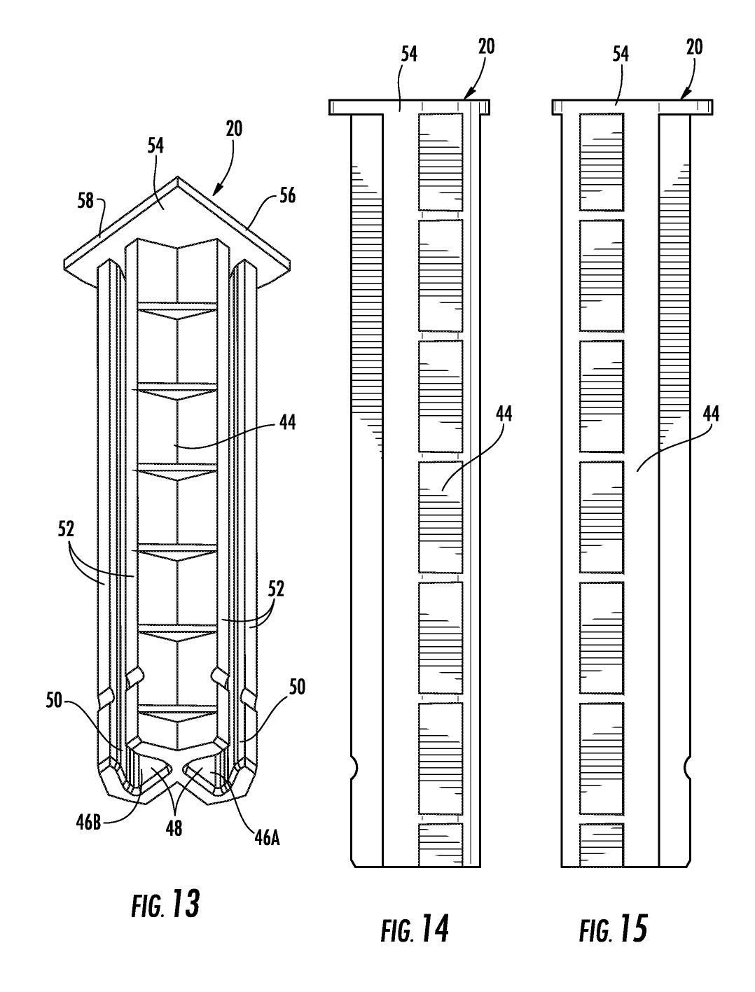

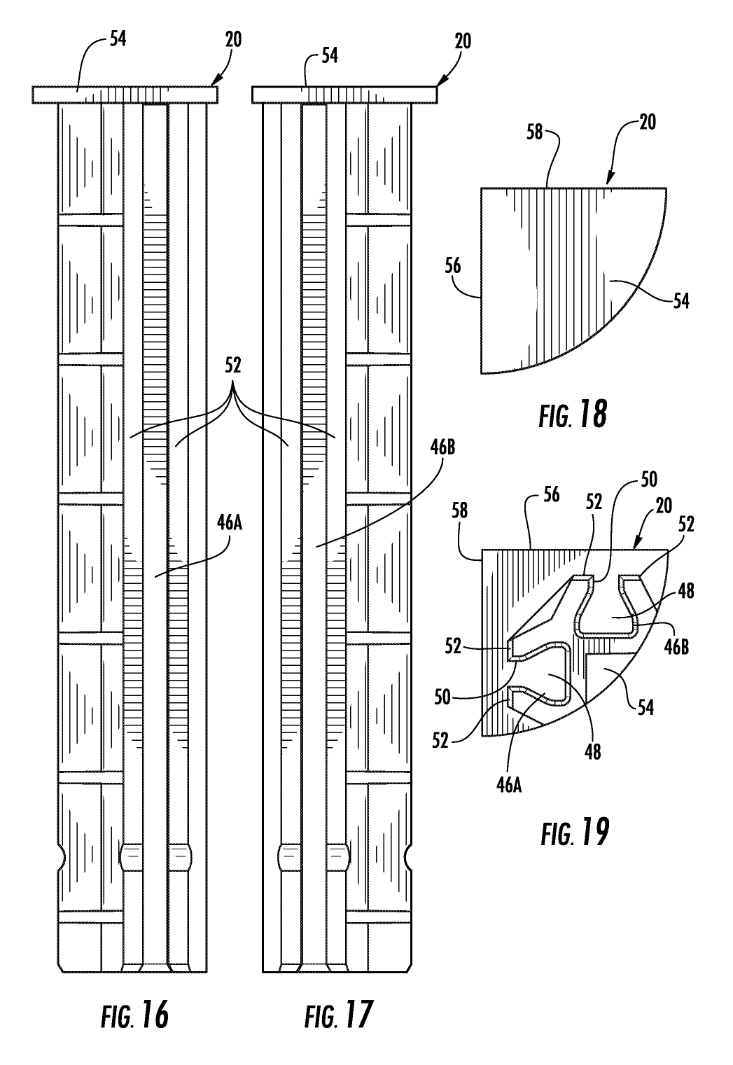

Referring now to the drawings, the corner joint system of the instant invention is illustrated and generally indicated at 10 in FIGS. 1-19.

As will hereinafter be more fully described, the instant invention provides a corner joint system 10 for fastening first and second furniture panels 12, 14 arranged in perpendicular, adjacent relation to form a rigid, right angle box corner. In the exemplary embodiments as described herein, the two furniture panels 12, 14 comprise two adjacent panels of a drawer box to be fastened at a right angle. As illustrated in the drawings, the drawer box also includes a floor panel generally indicated at 16. While the exemplary embodiment is described in connection with the assembly of drawer boxes, it is contemplated that the present corner joint system 10 could be employed in a variety of different types of furniture pieces requiring a fastener system for securing a variety of size and shape panels at right angles. Such embodiments might include, but should not be limited to structural walls, shelves, dividers, etc. It should also be understood that use of the corner joint system 10 should not be limited only to right angle (90 degree) box corners. The overall concept and teaching of the invention is equally applicable to box corners which may be greater than 90 degrees or less than 90 degrees.

Returning now to FIGS. 1-5, the corner joint system 10 generally includes first and second male connector rails 18A, 18B (also generally identified as 18) and a female connector rail 20 which interlocks with the male connector rails 18A, 18B. Both the male and female connector rails 18, 20 are preferably molded from a substantially rigid plastic material using conventional molding techniques.

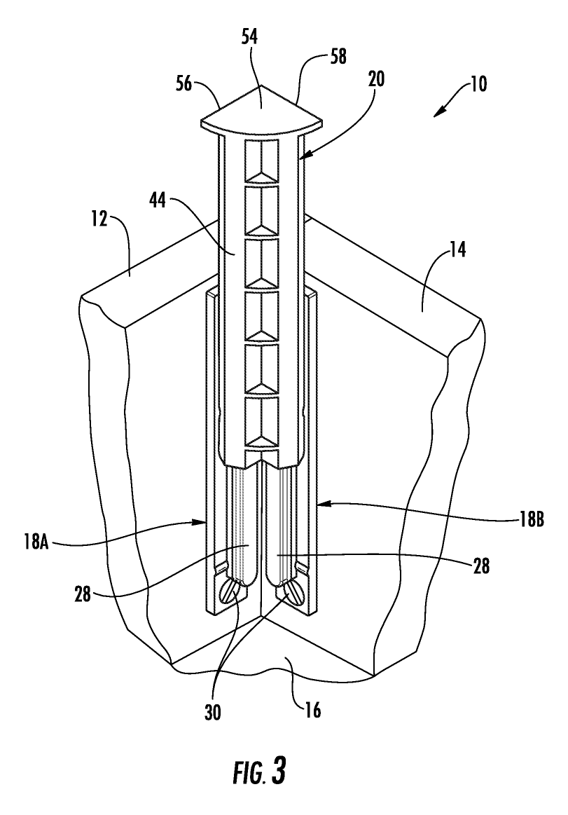

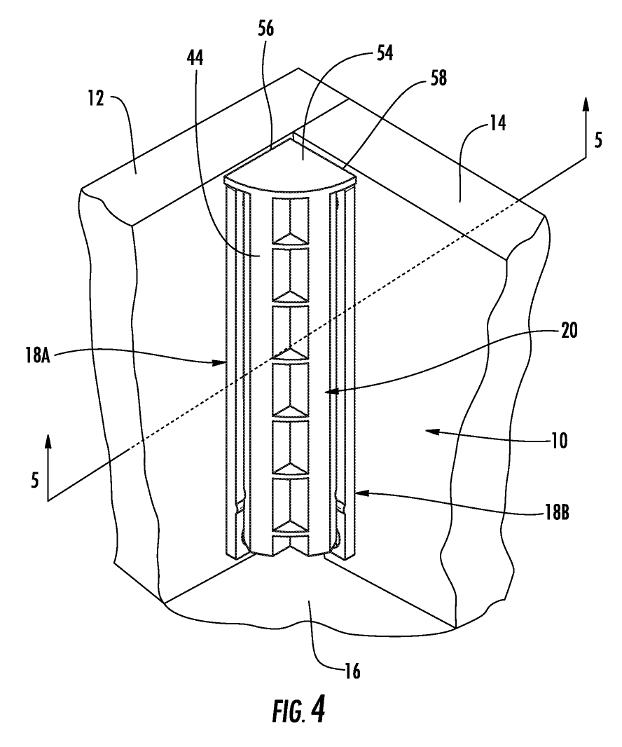

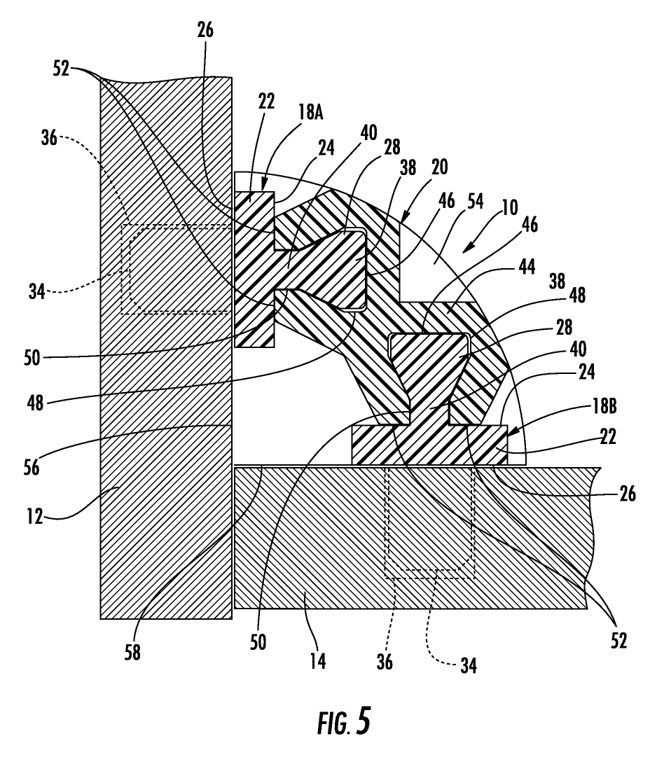

Turning to FIGS. 6-12, the first and second male connector rails 18 each include an elongated, rectangular base 22 having a planar inner surface 24 and a planar outer surface 26, and a longitudinal spline 28 extending perpendicularly, inward from the inner surface 24. In use, the first and second male connector rails 18A, 18B are secured in perpendicular adjacent relation to perpendicular adjacent corner surfaces of the furniture panels 12, 14 such that the respective splines 28 are arranged in adjacent perpendicular relation (See FIGS. 1-2). Preferably, the male connector rails 18 are secured using threaded fasteners 30 which extend through preformed apertures 32 in the opposing upper and lower ends of the bases 22. Other types of fasteners are also contemplated. Additionally, the male connector rails 18 each include a pair of spaced alignment posts 34 which extend perpendicularly outward from the outer surfaces 26 of the bases 22. These alignment posts 34 are seated into pre-drilled holes 36 (See FIG. 5) provided in the inner wall surfaces of the furniture panels 12, 14.

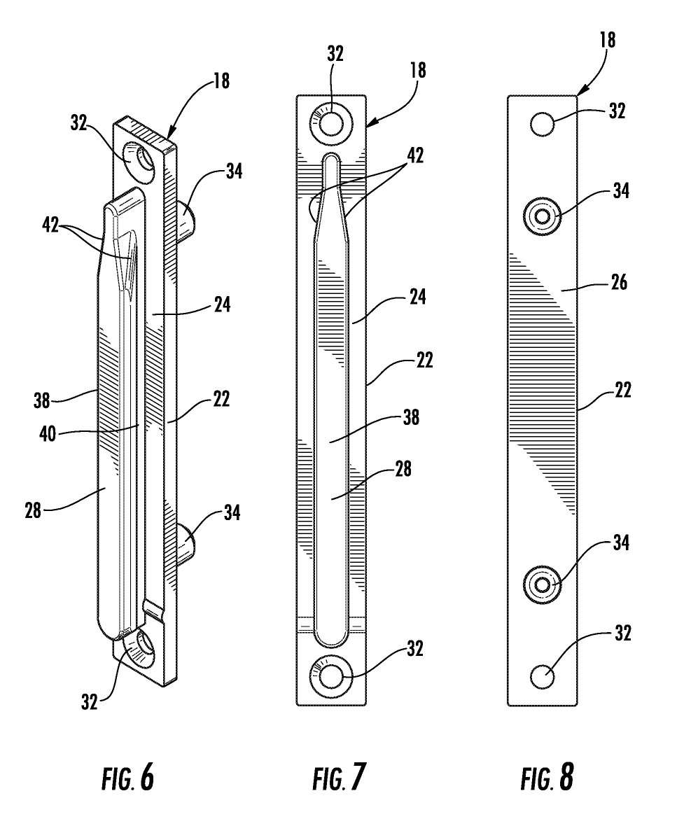

The spline 28 of the male connector rail 18 generally includes a wider body portion 38 and a narrower web portion 40 which connects the body portion 38 to the inner surface 24 of the base 22. In particular, it can best be seen in FIGS. 11-12 that the spline 28 is preferably dovetail shaped in cross-section, with a wider body portion 38 tapering to the narrower web portion 40. However, other spline shapes are also contemplated. The upper end of the spline 28 further includes symmetrical ramped surfaces 42 to facilitate sliding interfitting engagement of the female connector rail 20 over the male connector rail 18 (See FIGS. 6 and 7).

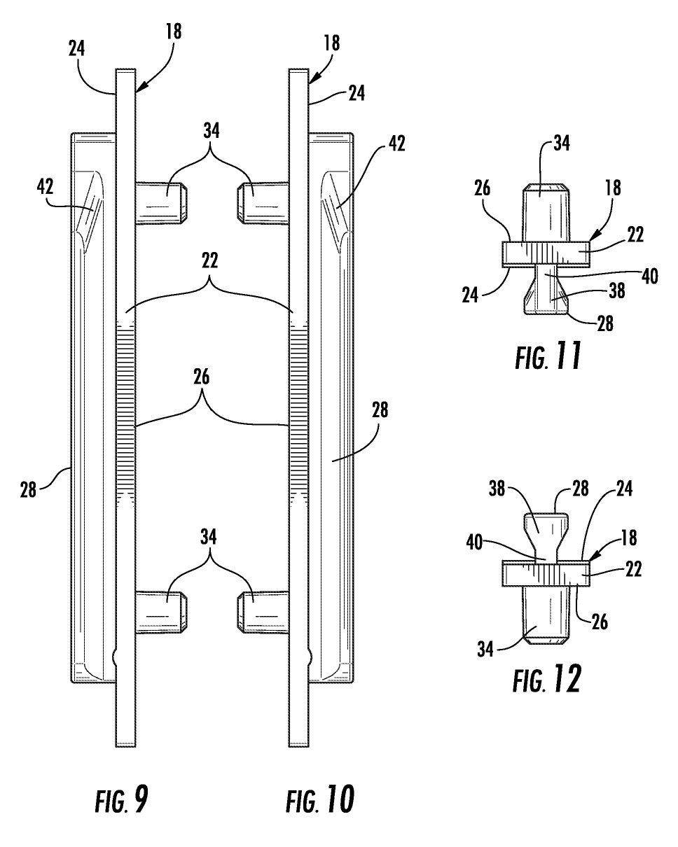

Turning to FIGS. 13-19, the female connector rail 20 includes a main body portion 44 having an upper end and a lower end, and two perpendicular, longitudinal, spline channels 46A, 46B (also generally identified as 46) extending upwardly through the main body portion 44 from the lower end toward the upper end. The spline channels 46 each have a shape which is complementary to the shape of the splines 28 having a wider inner channel portion 48 which receives the wider body portion 38 of the spline 28 and a narrower slot portion 50 which receives the narrower web portion 40 of the spline 28. Specifically, referring to FIGS. 5 and 19, it can be seen that the spline channels 46 are also dovetail shaped in cross-section and interfit in a snug, friction fit with the splines 28. The friction fit of the splines 28 within the channels 46 prevents the female connector rail 20 from inadvertently becoming disassembled from the male connector rails 18.

Turing back to FIGS. 1-5, it is contemplated that a primary use of the corner joint system 10 will be in the ready to assemble (RTA) furniture industry, for example, as described above, to provide a simple and effective way for buyers to assemble drawer boxes. In this regard, the male connector rails 18 are first assembled with the corner surfaces of the drawer box panels 12, 14 by inserting the alignment posts 34 into the pre-drilled holes 36 in the panels 12,14, making sure that the ramped ends 42 of the splines 28 face upwardly, and securing the male connector rails 18 with the screw fasteners 30 as provided. In some cases, the manufacturer will install the male connector rails 18 at the factory to insure better quality control in the orientation and tightening of the fasteners 30.

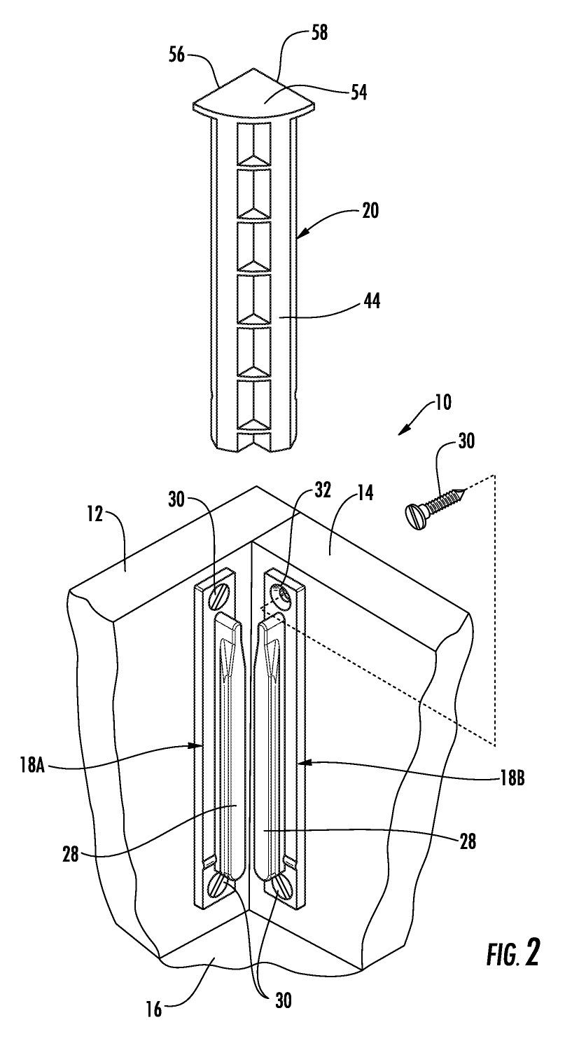

The user then simply aligns the corners of the drawer box panels 12, 14 in adjacent perpendicular relation, so that the respective splines 28 are arranged in adjacent perpendicular relation and slides the female connector rail 20 over the male connector rails 18A, 18B to complete the assembly (See FIGS. 3-4). In this regard, the spline channels 46A, 46B of the female connector rail 20 are slidably received in snug interfitting relation over the adjacent splines 28 of the male connector rails 18A, 18B to cooperatively capture the splines 28, draw the panels 12,14 together, interlock the rails 18, 20 and retain the panels 12,14 in assembled relation to form a rigid, right angle box corner. As indicated above, the ramped symmetrical surfaces 42 at the upper ends of the splines 28 facilitate insertion of the splines 28 into the channels 46 and generally aid in guiding proper assembly of the female connector rail 20.

Referring to FIG. 5 it can also be appreciated that there are several other engagement surfaces which aid in maintaining a rigid, right angle interconnection between all of the components. For example, it can be seen that the female connector rail 20 includes planar surfaces 52 adjacent the openings of the slot portions 50 of the spline channels 46. The inner surfaces 24 of the male connector rails 18 are received in engaged facing relation with these planar surfaces 52 to further facilitate a rigid, right angle connection.

In addition, the female connector rail 20 include a quadrant-shaped cap 54 having perpendicular side edges 56, 58 which are received in engaged facing relation with the furniture panels 12, 14 to facilitate formation of rigid, right angle box corner.

It was described hereinabove that the corner joint system 10 was also applicable to corner joints that were greater than 90 degrees or less than 90 degrees. In such cases, it is contemplated that angle of the spline channels 46 of the female connector rail 20 would simply be adjusted to accommodate the particular desired angle of attachment of the furniture panels and that the shape of the cap 54 of the female connector rail 20 would be similarly adjusted.

For these reasons, the instant invention is believed to represent a significant advancement in the art which has substantial commercial merit.

While there is shown and described herein certain specific structure embodying the invention, it will be manifest to those skilled in the art that various modifications and rearrangements of the parts may be made without departing from the spirit and scope of the underlying inventive concept and that the same is not limited to the particular forms herein shown and described except insofar as indicated by the scope of the appended claims.

What is claimed is:

1. A corner joint system for fastening two furniture panels arranged in perpendicular relation to form a box corner, said system comprising:
first and second male connector rails each comprising a base having an inner surface and an outer surface, and a longitudinal spline extending inwardly from said inner surface,
said first and second male connector rails being secured in perpendicular adjacent relation to perpendicular adjacent corner surfaces of said furniture panels such that said respective splines are arranged in adjacent perpendicular relation; and
a female connector rail comprising a main body portion having an upper end and a lower end, and two perpendicular, longitudinal, spline channels extending upwardly through said main body portion from said lower end toward said upper end, said spline channels each having a shape which is complementary to a shape of said splines,
said female connector rail interlocking with said first and second male connector rails wherein said spline channels of said female connector rail are slidably received in interfitting relation over said adjacent splines of said male connector rails to cooperatively capture said splines and retain said furniture panels in assembled relation forming a rigid, right angle box corner.

2. The corner joint system of claim 1 wherein said spline and said channels are dovetail shaped when viewed in cross-section.

3. The corner joint system of claim 1 wherein said inner surfaces of said bases of said male connector rails are substantially planar, and further wherein said main body portion of said female connector rail includes perpendicular planar surfaces adjacent said spline channels,
said inner surfaces of said male connector rails being received in engaged facing relation with said planar surfaces adjacent said spline channels to facilitate formation of a rigid, right angle box corner.

4. The corner joint system of claim 2 wherein said inner surfaces of said bases of said male connector rails are substantially planar, and further wherein said main body portion of said female connector rail includes perpendicular planar surfaces adjacent said spline channels,
said inner surfaces of said male connector rails being received in engaged facing relation with said planar surfaces adjacent said spline channels to facilitate formation of a rigid, right angle box corner.

5. The corner joint system of claim 1 wherein said female connector rail includes a quadrant shaped cap having perpendicular edges which are received in engaged facing relation with said furniture panels to facilitate formation of a rigid, right angle box corner.

6. The corner joint system of claim 2 wherein said female connector rail includes a quadrant shaped cap having perpendicular edges which are received in engaged facing relation with said furniture panels to facilitate formation of a rigid, right angle box corner.

7. The corner joint system of claim 3 wherein said female connector rail includes a quadrant shaped cap having perpendicular edges which are received in engaged facing relation with said furniture panels to facilitate formation of a rigid, right angle box corner.

8. The corner joint system of claim 4 wherein said female connector rail includes a quadrant shaped cap having perpendicular edges which are received in engaged facing relation with said furniture panels to facilitate formation of a rigid, right angle box corner.

9. The corner joint system of claim 1 wherein said splines of said male connector rails include a ramped surface at an upper end thereof to facilitate sliding interfitting engagement of said channels over said splines.

10. The corner joint system of claim 2 wherein said splines of said male connector rails include a ramped surface at an upper end thereof to facilitate sliding interfitting engagement of said channels over said splines.

11. The corner joint system of claim 3 wherein said splines of said male connector rails include a ramped surface at an upper end thereof to facilitate sliding interfitting engagement of said channels over said splines.

12. The corner joint system of claim 4 wherein said splines of said male connector rails include a ramped surface at an upper end thereof to facilitate sliding interfitting engagement of said channels over said splines.

13. The corner joint system of claim 5 wherein said splines of said male connector rails include a ramped surface at an upper end thereof to facilitate sliding interfitting engagement of said channels over said splines.

14. The corner joint system of claim 6 wherein said splines of said male connector rails include a ramped surface at an upper end thereof to facilitate sliding interfitting engagement of said channels over said splines.

15. The corner joint system of claim 7 wherein said splines of said male connector rails include a ramped surface at an upper end thereof to facilitate sliding interfitting engagement of said channels over said splines.

16. The corner joint system of claim 8 wherein said splines of said male connector rails include a ramped surface at an upper end thereof to facilitate sliding interfitting engagement of said channels over said splines.

17. A corner joint system for fastening two furniture panels to form a box corner, said system comprising:
first and second male connector rails each comprising a base having an inner surface and an outer surface, and a longitudinal spline extending inwardly from said inner surface,
said first and second male connector rails being secured in to adjacent corner surfaces of said furniture panels such that said respective splines are arranged in adjacent relation; and
a female connector rail comprising a main body portion having an upper end and a lower end, and two longitudinal, spline channels extending upwardly through said main body portion from said lower end toward said upper end, said spline channels each having a shape which is complementary to a shape of said splines,
said female connector rail interlocking with said first and second male connector rails wherein said spline channels of said female connector rail are slidably received in interfitting relation over said adjacent splines of said male connector rails to cooperatively capture said splines and retain said furniture panels in assembled relation forming a rigid box corner.

18. The corner joint system of claim 17 wherein said spline and said channels are dovetail shaped when viewed in cross-section.

19. The corner joint system of claim 17 wherein said inner surfaces of said bases of said male connector rails are substantially planar, and further wherein said main body portion of said female connector rail includes planar surfaces adjacent said spline channels,
said inner surfaces of said male connector rails being received in engaged facing relation with said planar surfaces adjacent said spline channels to facilitate formation of a rigid box corner.

20. The corner joint system of claim 18 wherein said inner surfaces of said bases of said male connector rails are substantially planar, and further wherein said main body portion of said female connector rail includes planar surfaces adjacent said spline channels,
said inner surfaces of said male connector rails being received in engaged facing relation with said planar surfaces adjacent said spline channels to facilitate formation of a rigid box corner.
